(19) United States
(12) Patent Application Publication
(10) Pub. No.: US 2003/0106072 A1
(43) Pub. Date: Jun. 5, 2003

(54) Multimedia storage and control system

(75) Inventor: Aravind Soundararajan, Ossining, NY (US)

Correspondence Address: Corporate Patent Counsel, U.S. Philips Corporation, 580 White Plains Road, Tarrytown, NY, 10591, US

(73) Assignee: Koninklijke Philips Electronics N.V.

(21) Appl. No.: 10/011,619

(22) Filed: Dec. 5, 2001

(51) Int. Cl. H04N 7/16

(52) U.S. Cl. 725/151; 725/153; 725/147

(57) ABSTRACT

A multimedia storage and control system for storing multimedia content includes a multimedia interface for receiving the multimedia content from a multimedia stream. The multimedia storage and control system further includes a personal computer. The personal computer is adapted for communicating with the multimedia interface and may be configured to perform operations such as selectively storing at least a portion of the multimedia content received from the multimedia interface in response to a storage request, and transmitting at least a portion of the multimedia content stored in the memory associated with the personal computer to the multimedia interface in response to a retrieval request.

### FIELD OF THE INVENTION

The present invention relates generally to data storage and control systems, and more specifically relates to techniques for storing and controlling multimedia content on a personal computer.

### BACKGROUND OF THE INVENTION

Use of the personal computer (PC) in the home not merely as a business tool but as an entertainment platform is becoming more and more prevalent, due primarily to the affordability of relatively high-end systems and the availability of various application programs running on such systems. For example, consider that a PC having a peripheral device such as a joy stick or similar gaming controller may be utilized for playing video games and the like, essentially obviating the need for a dedicated video gaming system. Similarly, another recent trend is to use the PC, in conjunction with a compact disk (CD) or digital versatile disk (DVD) peripheral, as a home theater system for listening to audio CDs or viewing DVD movies, thereby replacing the dedicated CD/DVD player or video cassette recorder (VCR).

Unfortunately, PCs still have certain limitations that hamper outright elimination of traditional home entertainment systems, which generally include a television set and home stereo. Such limitations associated with a PC may include, for example, a small display screen size (e.g., 19 inches or less) in comparison to a television set (e.g., 32 inches or more) or projection screen set (e.g., 50 inches). Moreover, PCs rarely have the necessary audio power output capability to drive home theater speakers. Thus, the PC has been used in combination with one or more traditional home theater components, such as, for example, a large-screen video monitor and/or audio amplifier system for feeding audio and/or video signals from a PC into the home theater system.

Conventionally, a television system has been integrated with a PC system for displaying audio/video output from the PC on the television set. Such an arrangement has been used, for example, to provide Internet Web browsing capabilities to a home theater user, without the need for a dedicated set-top box (STB) or other special-purpose device, such as, for example, WebTV (a trademark of WebTV Corporation). Moreover, the PC has been used to control certain functionalities of a conventional STB. For example, U.S. Pat. No. 5,982,363 to Naiff discloses using a peripheral device in conjunction with a PC to replace an STB for television reception. The peripheral device includes a television interface for enabling the PC to receive, select and process television signals in real-time. The Naiff patent, however, is not directed to the storage of multimedia broadcast signals for playback at a later time, a procedure known as “time-shifting.”

A personal video recorder (PVR) is a device capable of storing real-time broadcast signals and playing back such signals at a predetermined time. Such a PVR device is presently commercially available from, for example, TiVo Inc. However, the TiVo PVR is a dedicated device and therefore does not utilize the capabilities of already existing hardware. Moreover, because the PVR is a dedicated device, it cannot be used for other audio/video entertainment applications. Consequently, this device is a costly addition to a home theater system.

Accordingly, there is a need in the art for techniques which facilitate storing real-time multimedia broadcast signals in a cost-effective manner, without the need for dedicated hardware.

### SUMMARY OF THE INVENTION

Techniques are provided for merging multimedia with a personal computer (PC) by storing real-time multimedia signals received from a broadcast stream on a PC for processing and/or retrieval at a later time. By utilizing hardware, such as, for example, random access memory (RAM), hard disk drives, etc., already existing in the standard PC, the need for dedicated storage devices, such as, for example, a TiVo device, is advantageously eliminated. Thus, the present invention may be utilized in conjunction with a home multimedia system as a cost-effective personal multimedia recorder and time-shift player.

In accordance with one aspect of the present invention, a system for storing multimedia information received from a real-time broadcast multimedia stream for retrieval and/or processing at a predetermined time includes a PC and a multimedia interface, which may be, for example, a set-top box (STB) or digital television (DTV) unit. The PC receives the multimedia information from the multimedia interface via a communication channel, preferably a wireless link, established between the PC and the multimedia interface. The received multimedia information is stored in memory residing in and/or connected to the PC for later retrieval and/or processing.

These and other objects, features and advantages of the present invention will become apparent from the following detailed description of illustrative embodiments thereof, which is to be read in connection with the accompanying drawings.

### BRIEF DESCRIPTION OF THE DRAWINGS

FIG. 1 is a block diagram illustrating a system for storing multimedia information on a personal computer, in accordance with one aspect of the invention.

FIG. 2 is a block diagram illustrating a transfer of multimedia information between a set-top box/digital television and a personal computer, in accordance with the present invention.

FIG. 3 is a logical flow diagram illustrating an exemplary procedure for completing a service transaction between a multimedia device and a personal computer, in accordance with the present invention.

### DETAILED DESCRIPTION OF PREFERRED EMBODIMENTS

The present invention will be described below in the context of a personal video recorder (PVR) system. It is to be understood, however, that the present invention is not limited to this or any particular multimedia application. Rather, the invention is more generally applicable to storing and controlling multimedia content on a personal computer (PC), in accordance with the methodologies set forth herein.

The term “personal computer” as used herein is intended to include not only desktop, laptop or other fixed or portable computers, but also other computing devices, such as, but not limited to, personal data assistants (PDAs).

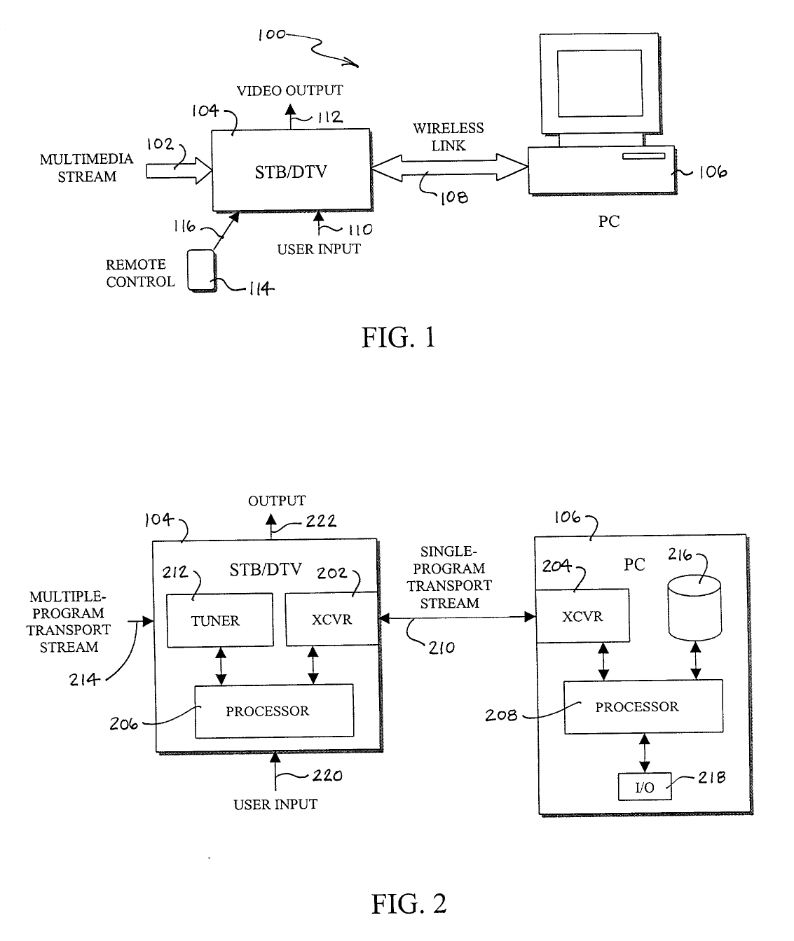

FIG. 1 illustrates an exemplary system 100 for selectively storing, retrieving or otherwise processing multimedia content on a PC, in accordance with one aspect of the invention. As previously stated, the system of the present invention may be used in a PVR application, for instance, for performing cost-effective time-shifting (i.e., playing back time-delayed multimedia content) of predetermined real-time broadcast programs, without the need for a dedicated storage device (e.g., a TiVo device). The system 100 includes a multimedia interface 104 which may be implemented as, for example, a set-top box (STB) and/or digital television (DTV), although other suitable alternatives may be used to implement the multimedia interface (e.g., a television (TV)).

The multimedia storage system 100 further includes a PC 106 operatively coupled to the STB/DTV 104 via a communication channel 108. Although the communication channel 108 is preferably a wireless communication link, such as, for example, radio frequency (RF), satellite, microwave, infrared (IR), etc., the term “channel” as used herein is intended to refer generally to any type of communication medium for conveying transmitted information, including a dedicated communication connection, such as, for example, telephone, cable, fiber optic, etc.

The STB/DTV 104 preferably includes an output 112 (e.g., video output) for presenting multimedia content to a video display monitor (not shown), or a suitable alternative thereof. The STB/DTV 104 also includes a user input 110 through which one or more functions of the STB/DTV may be controlled by a viewer, such as, for instance, channel selection, volume adjustment, etc. For added viewing convenience, the multimedia storage system 100 may include a remote control unit 114 which operatively interfaces with the STB/DTV 104, preferably by way of a wireless link 116 (e.g., infrared). The remote control unit 114 preferably operates in conjunction with the STB/DTV 104 for remotely viewing and/or modifying one or more features, options and/or settings of the STB/DTV. Additionally, the remote control unit 114 may be configured to control one or more features, options and/or settings of other multimedia devices, for example, a television receiver, DVD player, audio amplifier, etc., which may comprise the viewer's home theater system, thus essentially eliminating the need for a separate remote control unit for each device.

The remote control unit 114 may be a conventional device which includes one or more function keys or buttons that are uniquely specific to the operation of STB/DTV 104. For example, the remote control unit 114 may include up, down, right and left buttons for positioning a cursor or similar viewer-manipulated operator and highlighting or selecting a desired object or area on a menu displayed on a monitor operatively connected to the STB/DTV 104 via video output 112. Similarly, the remote control unit 114 may include a number of buttons having functions that can be universally employed to control other multimedia equipment (e.g., power, channel up/down, volume up/down, etc.) in a conventional manner.

As apparent from the figure, the STB/DTV 104 includes a multimedia source input for receiving multimedia content from a multimedia stream 102. The term “multimedia stream” as used herein is intended to refer to signals that may originate from a cable, satellite, or terrestrial broadcast, or from an alternative multiple-program stream. The multimedia content preferably includes, but is not limited to, broadcast television video signals, such as National Television Standards Committee (NTSC) signals, DTV signals, and high definition television (HDTV) signals. The multimedia content may also include still images, audio signals (e.g., from a satellite radio source), etc. The STB/DTV 104 may include multiple multimedia inputs and a multiplexer or equivalent switching circuitry (not shown) for selecting one of a plurality of multimedia sources (e.g., video camera, digital still camera, etc.).

With reference now to FIG. 2, a graphical representation illustrating some of the functional components comprising the exemplary STB/DTV 104 and PC 106 is shown, in accordance with the present invention. As apparent from the figure, the STB/DTV 104 includes a broadcast tuner 212 which is coupled to the multimedia stream, preferably a multiple-program transport stream 214. The tuner 212 preferably demodulates real-time multimedia signals received from the multiple-program transport stream 214, for example, a terrestrial source, a satellite, or from a cable television system, in a conventional manner for subsequent storage and/or processing (e.g., data compression, encoding, etc.). The demodulated broadcast signal may also be displayed in real-time on a monitor or other presentation device (not shown) coupled to the STB/DTV 104 via output 222.

The STB/DTV 104 may include a processor 206 which is preferably used to run application programs for controlling one or more functions of the STB/DTV. It is to be appreciated that the term “processor” as used herein is intended to include any processing device, such as, for example, one that includes a central processing unit (CPU) and/or other processing circuitry (e.g., microprocessor). Additionally, it is to be understood that the term “processor” may refer to more than one processing device, and that various elements associated with a processing device may be shared by other processing devices.

The processor 206 is preferably coupled to memory (not shown), either internal or external to the STB/DTV 104, which may include random access memory (RAM), read only memory (ROM), fixed storage (e.g., a hard drive), removable storage media (e.g., a diskette), flash memory, etc., for storing data associated with the STB/DTV 104 (e.g., viewer preferences, program data, etc.). Furthermore, one or more input/output (I/O) devices (not shown) may be coupled to the processor 206 for entering data to the processor (e.g., a keyboard/keypad), such as through user input 220, and/or presenting results associated with the processor (e.g., a monitor), such as through output 222. Accordingly, an application program, or software components thereof, including instructions or code for performing at least a portion of the methodologies of the invention, as will be described further below, may be stored in one or more of the associated storage media (e.g., ROM). When such a program is ready to be utilized, it may be loaded in whole or in part (e.g., into RAM) and executed by the processor 206.

With continued reference to FIG. 2, the PC 106 is preferably fashioned in a conventional manner. Specifically, the PC 106 may include a processor 208, memory 216 and I/O devices 218. In a manner consistent with the STB/DTV 104 previously described, processor 208 is preferably used to run application programs for operatively storing, retrieving, or otherwise processing multimedia content on the PC 106, in accordance with at least a portion of the methodologies of the present invention. The term “I/O devices” as used herein is intended to include, for example, one or more input devices (e.g., keyboard, mouse, etc.) for entering data to the processor, and/or one or more output devices (e.g., printer, monitor, etc.) for presenting the results associated with the processor.

Preferably, the STB/DTV 104 and the PC 106 include wireless network transceivers 202 and 204, respectively, for communicating with one another, or other devices, over communication channel 210, which in this illustrative embodiment includes a single-program transport stream established between the STB/DTV and the PC. It is to be understood that the term “single-program transport stream” as used herein is not intended to be limited to the standard Motion Picture Experts Group (MPEG) definition which refers to both transport streams and program streams (e.g., used by CDs and DVDs). Furthermore, it is to be appreciated that the communication channel 210 may comprise more than one single-program transport stream for concurrently storing multimedia content on the PC 106 from the STB/DTV 104 and for retrieving multimedia content from the PC, as required in a multimedia time-shifting application. Thus, communication channel 210 is preferably bi-directional.

The wireless network transceivers 202, 204 in the STB/DTV 104 and PC 106, respectively, preferably communicate with one another using a standard wireless networking protocol. Communication protocols suitable for use with the present invention include, but are not limited to, HomeRF (a trademark of HomeRF Working Group, Inc), Bluetooth (a trademark of Ericsson Corporation), Institute of Electrical and Electronics Engineers (IEEE) 1394 (wired or wireless), Universal Serial Bus (USB) 2.0 (wired or wireless), etc. The HomeRF protocol specification, for example, defines a common interface that supports wireless voice and data networking in a close proximity environment (e.g., within a range of about 10 to 20 feet), such as in a home.

The Bluetooth baseband specification, as set forth in J. Haartsen, “Bluetooth Baseband Specification,” Version 1.0, which is incorporated herein by reference, defines a Bluetooth point-to-point connection establishment as a two step procedure. When Bluetooth units do not have any knowledge about their neighbors, they must initially perform an “inquiry procedure” in order to discover the neighborhood information (e.g., node identities and synchronization information). Once the neighborhood information is available, a “paging procedure” is subsequently employed in order to establish the actual connection between devices.

Present wireless networking protocols are able to accommodate the bandwidth necessary for single-program or multiple-program streaming between the STB/DTV 104 and the PC 106. For example, a HomeRF 2.0 protocol provides a data rate of about 10 megabits per second (Mbps), which is sufficient for single-program standard definition (e.g., NTSC) streaming. The IEEE 802.11a wireless local area network (WLAN) specification provides a data rate of 54 Mbps over a range of about 100 meters. Other protocols, such as, for example, USB 2.0 or IEEE 1394 provide data rates of up to 480 Mbps, which is capable of supporting multiple-program high-definition streaming. For performing time-shifting, a bi-directional communication channel 210 is required between the STB/DTV 104 and the PC 106, wherein a first channel is used for storing selected real-time multimedia content on the PC from the STB/DTV 104 and a second channel is used for retrieving time-shifted multimedia content that has been stored in memory 216 associated with the PC 106.

By using an open communication protocol common to all multimedia appliances, one or more PCs can advantageously serve as a distributed storage media for one or more multimedia devices (e.g., STB, DTV, TV, etc.). It is to be appreciated, however, that a proprietary or closed network protocol may also be used between the wireless network transceivers 202, 204 in the STB/DTV 104 and PC 106, respectively. An advantage of using a proprietary communication protocol for communicating between each of the multimedia devices and the PC may be that other devices employing different protocols will be less likely to interfere with the multimedia storage system of the present invention. Moreover, with a proprietary protocol, multimedia device manufacturers can more closely control device compatibility compared to an open communication protocol.

As previously stated, the multimedia storage system of the present invention may comprise one or more multimedia devices and one or more PCs. Each of the multimedia devices and PCs preferably include wireless capability and may be operatively connected together to form nodes in a wireless network. Wireless networks typically make use of service discovery and join protocols to identify the services offered by other devices connected to the network. Service discovery protocols, such as, for example, Jini (a trademark of Sun Microsystems, Inc.) or Universal Plug and Play (UPnP), may be used in accordance with the present invention, for example, to initiate a multimedia storage procedure in a given PC. Other services may include, for example, retrieving and/or processing stored multimedia content from a given PC, or initiating a multimedia time-shifting operation.

As understood by those skilled in the art, when a compatible device plugs in to a network of the type describe above, it typically goes through an add-in procedure which may include service discovery and join protocols. In accordance with the add-in procedure, the device first locates a lookup service (discovery) and then uploads an object that implements all of its services' interfaces (join). The lookup service acts as an intermediary to connect a client searching for a particular service with that desired service. Once connection is made, the lookup service is removed from further participation between that client and the desired service.

A service discovery protocol will now be described which is suitable for use with the present invention. Devices sharing a common networking protocol generally first define a service interface that client devices or nodes can access. A service proxy is then implemented to handle service requests from client devices in the network. A registry of services is preferably employed to keep track of available services in the network. Next, a joining process is employed by registering a service item with a desired lookup service. A discovery process is implemented which is used for identifying a network manager, determining available bandwidth, making or breaking connections, etc. In many wireless protocols, any device can act as a network manager depending upon the connection setup. For overall control of network objects, a central control may be implemented. This device or node will be utilized during the discovery process to provide the necessary lookup service and make/break connections between devices and otherwise provide arbitration between devices.

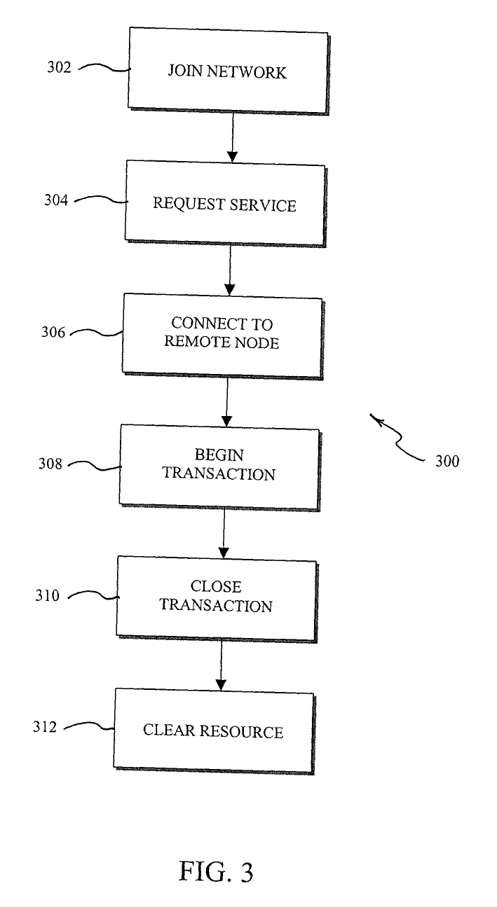

FIG. 3 illustrates an exemplary procedure 300 for performing a service transaction, in accordance with one aspect of the present invention. Service transactions may include, for example, storing a selected real-time broadcast program on a PC or retrieving a stored program from the PC for viewing, as previously described. As apparent from the figure, prior to beginning a transaction, a client (e.g., STB) must join the network, as represented by block 302. Devices may join the network using, for example, a joining process, as described above. Next, the client searches for an available service of interest (e.g., multimedia storage or time-shift playback). This may be accomplished by multicasting a service request over the network (e.g., transmitting the request to every device connected to the network) in block 304.

Once the client identifies the particular device (e.g., PC) that it needs to communicate with, a connection between the client and the remote device is operatively established in block 306. Subsequently, a distributed transaction process can be initiated to begin the desired transaction in block 308 for processing the required data. After the transaction has completed in block 310, the service resource is released or cleared in block 312 and the designated network manager node is notified of the completion of the process.

As an illustration of the methodologies of the present invention described herein, consider an exemplary time-shifting application. In this scenario, the STB/DTV receives a multiple-program transport stream as input. A viewer then selects a desired program to record, for example, using selection controls associated with the STB/DTV. Such program selection may be pre-programmed by the viewer, for example, in a manner consistent with a record timer or VCR Plus+ (a trademark of Gemstar Development Corporation) feature found on many conventional video cassette recorders (VCR). The desired program is filtered from the input stream and then transmitted over the communication channel to the PC for storage as a single-program transport stream. The transport stream may be encrypted if desired, and present wireless communication standards support various encryption schemes, as known by those skilled in the art.

An application routine, implemented in hardware and/or software running on the PC, preferably identifies the input device as a STB/DTV (e.g., using a service discovery protocol) and automatically directs the PC to store the input stream in memory associated with the PC. When the viewer wishes to play back a selected program that is being concurrently stored in a time-shifted manner, the PC continues recording the program over one single-program transport stream and concurrently begins transmitting a stream to the STB/DTV over a second single-program transport stream from the point it started to record, thus giving the viewer a seamless transfer.

The present invention described herein utilizes existing PC-based storage media to provide a cost-effective mechanism for storing multimedia content, received, for example, from a real-time broadcast stream or other multimedia source, on a PC, thus eliminating the need for a dedicated storage device. By utilizing a wireless communication channel for communicating between a multimedia device and a PC, the PC and/or multimedia device need not be affixed to a particular location. Furthermore, by forming a wireless network of compatible multimedia devices and PCs, the methodologies of the present invention may be utilized as a distributed storage media for storing and/or controlling the presentation of multimedia content.

Although illustrative embodiments of the present invention have been described herein with reference to the accompanying drawings, it is to be understood that the invention is not limited to those precise embodiments, and that various other changes and modifications may be made therein by one skilled in the art without departing from the scope or spirit of the invention.

What is claimed is:

1. A multimedia storage and control system for storing multimedia content received from a multimedia stream and performing at least one of retrieval and processing of the multimedia content, the system comprising:
a multimedia interface adapted to receive the multimedia content from the multimedia stream; and
a personal computer, the personal computer being configured for communicating with the multimedia interface and receiving the multimedia content therefrom, and including memory for selectively storing at least a portion of the multimedia content received from the multimedia interface.

2. The system of claim 1, wherein the multimedia interface includes a processor configured to selectively perform at least one of transmitting multimedia content to the personal computer for storage and receiving multimedia content from the personal computer for display.

3. The system of claim 1, wherein the multimedia interface and the personal computer each include a wireless transceiver operatively couplable to one another via a wireless communication channel.

4. The system of claim 1, wherein the multimedia interface and the personal computer establish a wireless connection with one another via a service discovery protocol.

5. The system of claim 1, wherein the multimedia interface comprises a set-top box, the set-top box including a user input for controlling one or more functions of the set-top box.

6. The system of claim 1, further comprising:
a wireless remote control, the wireless remote control being configured to communicate with the multimedia interface for controlling one or more functions of the multimedia interface.

7. The system of claim 1, wherein the personal computer includes a processor configured to selectively perform at least one of receiving real-time multimedia content from the multimedia interface for storage and selectively transmitting multimedia content stored in memory associated with the personal computer to the multimedia interface for display.

8. A method of storing multimedia content on a personal computer, the method comprising the steps of:
establishing a connection between the personal computer and a multimedia interface;
receiving multimedia content from a multimedia stream coupled to the multimedia interface;
selecting a particular multimedia program from the multimedia stream for storage on the personal computer; and
transmitting the particular multimedia program to the personal computer via the connection established with the personal computer, the personal computer storing the particular multimedia program in memory associated with the personal computer.

9. The method of claim 8, wherein the step of establishing a connection with the personal computer comprises implementing at least one of a service discovery protocol and a join protocol.

10. The method of claim 8, further comprising the step of encoding the particular multimedia program prior to storage on the personal computer.

11. The method of claim 8, wherein the multimedia interface comprises a set-top box, and the method further comprises the step of controlling one or more functions of the set-top box.

12. An apparatus for use in a distributed multimedia storage and control system, the apparatus comprising:
a multimedia interface, the multimedia interface receiving multimedia content from a multimedia stream, the multimedia interface being operatively configured to establish a connection with a personal computer and perform at least one of:
storing selected multimedia content from the multimedia stream in memory associated with the personal computer; and
retrieving selected multimedia content from the memory associated with the personal computer.

13. The apparatus of claim 12, wherein the connection established between the multimedia interface and the personal computer is a wireless communication channel and the selected multimedia content is transferred between the multimedia interface and the personal computer via the wireless communication channel.

14. The apparatus of claim 12, wherein the multimedia interface comprises a wireless transceiver, the wireless transceiver being adapted to operatively communicate with at least a second wireless transceiver associated with the personal computer.

15. The apparatus of claim 12, wherein the connection between the multimedia interface and the personal computer is established using at least one of a service discovery protocol and a join protocol.

16. The apparatus of claim 12, wherein the multimedia interface comprises a set-top box, the set-top box including a user input for controlling one or more functions of the set-top box.

17. An apparatus for use in a multimedia storage and control system for processing multimedia content, the apparatus comprising:
memory; and
at least one processor coupled to the memory, the processor being operative to: (i) direct the apparatus to establish a connection between the apparatus and a multimedia interface; (ii) direct the apparatus to receive selected multimedia content from the multimedia interface; (iii) store the multimedia content in the memory in response to a storage request from the multimedia interface; (iv) retrieve selected multimedia content from the memory; and (v) direct the apparatus to transmit the multimedia content to the multimedia interface in response to a retrieval request from the multimedia interface.

18. The apparatus of claim 17, further comprising a wireless transceiver coupled to the at least one processor, the wireless transceiver being adapted to establish the connection between the apparatus and the multimedia interface.

19. The apparatus of claim 17, wherein the connection between the apparatus and the multimedia interface is established using at least one of a service discovery protocol and a join protocol.

20. The apparatus of claim 17, wherein the connection between the apparatus and the multimedia interface is established via a wireless communication channel.
